(19) United States
(12) Patent Application Publication
(10) Pub. No.: US 2017/0003014 A1
(43) Pub. Date: Jan. 5, 2017

(54) LED LAMP HOLDER FOR WATERPROOF LAMP STRING

(71) Applicants: Yao Wu Liu, Dongguan (CN); Kuo Chih Chen, Dongguan (CN)

(72) Inventors: Yao Wu Liu, Dongguan (CN); Kuo Chih Chen, Dongguan (CN)

(21) Appl. No.: 14/790,250

(22) Filed: Jul. 2, 2015

(51) Int. Cl. F21V 31/00; F21V 21/08

(52) U.S. Cl. CPC F21V 31/00; F21V 21/08; F21Y 2101/02

(57) ABSTRACT

An LED lamp holder for a waterproof lamp string includes a plastic casing and an LED luminaire. The LED luminaire includes a light emitting chip, an epoxy resin member, and a pin. The cylindrical epoxy resin member is in an inverted T-shape and has a large-diameter section and a small-diameter section. The plastic casing is in a circular tubular shape and has an LED connecting hole at the front and a wire exit at the rear. The plastic casing is filled up with a plastic filler. The points at the pins and the connecting wire are packaged with plastic. During the operation of the present invention, the light emitted by the light emitting chip is emitted directly from the small-diameter section of the epoxy resin member without being affected by the plastic casing and the color difference of the internal filled plastic filler.

### FIELD OF THE INVENTION

The present invention relates to the field of an LED lamp holder, in particular to the LED lamp holder for a waterproof lamp string.

### BACKGROUND OF THE INVENTION

An LED lamp string is commonly used in modern life for decoration, mood lighting and signage lighting, and the LED lamp string is divided into two types, respectively outdoor LED lamp string and indoor LED lamp string.

The outdoor LED lamp strings generally come with waterproof and dustproof functions to meet actual using requirements. To achieve the waterproof function of the outdoor LED lamp strings, a sealed plastic package is used to seal the whole LED lamp in the plastic package, and a plastic layer is used for sealing to achieve the waterproof and dustproof effects.

Although the aforementioned method can achieve the waterproof and dustproof functions, the actual application of the lamp holder still has drawbacks. More specifically, the plastic package is wrapped around the LED lamp, so that the light emitted from the LED lamp has to pass through the plastic package. However, each batch of the manufactured plastic packages usually come with a color difference due to factors such as different production batches, raw material ratios, and manufacturing temperatures. Therefore, the LED lamps of a lamp string may show a difference of colors. In addition, air bubbles may produced easily in the process of filling the plastic material, and the air bubbles may affect the light transmittance of the plastic package as well as the brightness of the LED lamp.

In summation, an LED lamp holder providing both waterproof and dustproof functions without affecting the color and brightness of the light emission is urgently needed.

### SUMMARY OF THE INVENTION

Therefore, it is a primary objective of the present invention to provide an LED lamp holder for a waterproof lamp string to overcome the drawbacks of the prior art.

To achieve the aforementioned objective, the present invention provides an LED lamp holder for a waterproof lamp string, and the LED lamp holder comprises a plastic casing and an LED luminaire, wherein the LED luminaire includes a light emitting chip, an epoxy resin member, a pin, a light emitting chip packaged into the cylindrical epoxy resin member and connected to the pin extended out from the epoxy resin member; each pin is connected to a connecting wire; the cylindrical epoxy resin member is substantially in an inverted T-shape and includes a large-diameter section and a small-diameter section; the plastic casing is substantially in a circular tubular shape and has an LED connecting hole formed at the front end of the plastic casing and a wire exit formed at the rear end of the plastic casing; the LED connecting hole has a diameter in corresponsive to the small-diameter section of the epoxy resin member; the whole LED luminaire is plugged into the plastic casing, and the small-diameter section of the epoxy resin member passes through and extends out from the LED connecting hole; and the plastic casing is filled up with a plastic filler, and the points at the pins and the connecting wire are packaged by plastic.

Preferably, there are two pins, and the two pins are fixed by a wire frame to provide a physical insulation.

During the operation of the present invention, the light emitted by the light emitting chip is emitted directly from the small-diameter section of the epoxy resin member without being affected by the plastic casing and the color difference of the internal filled plastic filler. The invention provides a waterproof sealing effect and guarantees the color and intensity of the lighting. For outdoor use, the plastic casing provides a primary waterproof sealing for the electrically conductive joint of the LED luminaire and the connecting wire, and the filling of the plastic filler provides a secondary waterproof sealing, and these two waterproof sealing measures provide a lamp holder with better waterproof and dustproof effects.

### BRIEF DESCRIPTION OF THE DRAWINGS

FIG. 1 is a schematic view of the present invention; and

FIG. 2 is a schematic view showing the combination of an LED luminaire and a wire frame of the present invention.

### DESCRIPTION OF THE PREFERRED EMBODIMENTS

The aforementioned and other objectives and advantages of the present invention will become clearer in light of the following detailed description of an illustrative embodiment of this invention described in connection with the drawings.

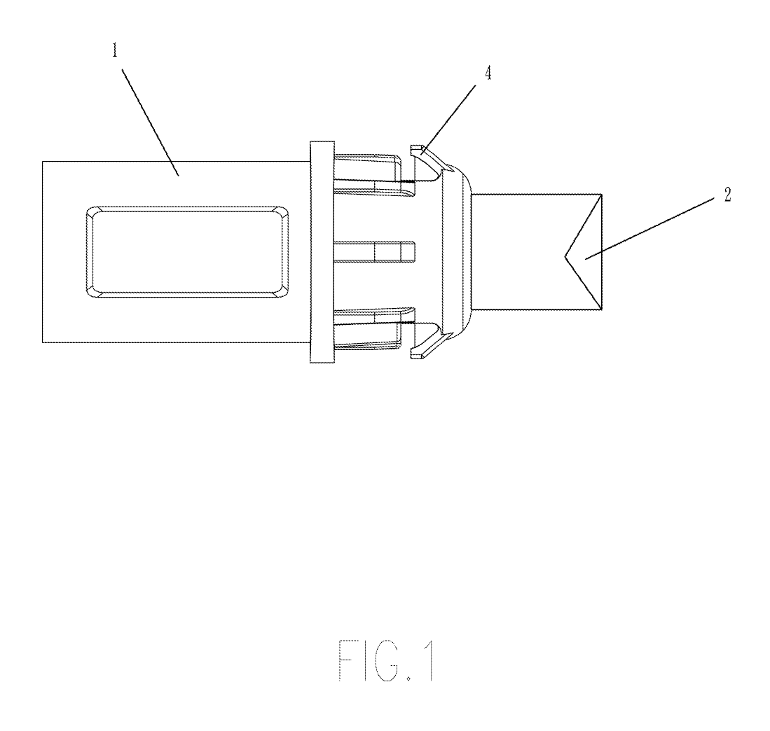

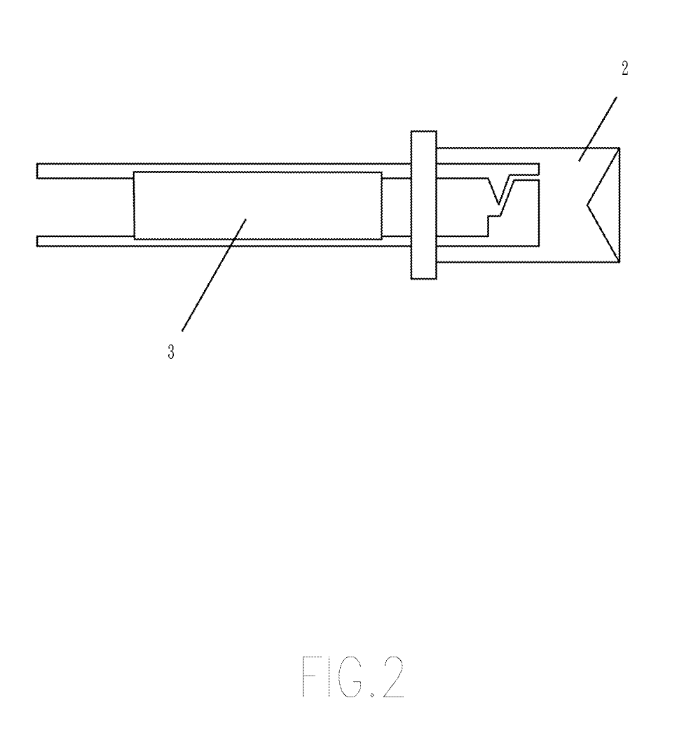

With reference to FIGS. 1 and 2 for an LED lamp holder for a waterproof lamp string in accordance with a preferred embodiment of the present invention, the LED lamp holder comprises a plastic casing 1 and an LED luminaire 2, wherein the LED luminaire 2 includes a light emitting chip, an epoxy resin member, a pin, a light emitting chip packaged in the cylindrical epoxy resin member and connected to the pin extended out from the epoxy resin member; each pin is connected to a connecting wire; the cylindrical epoxy resin member is substantially in an inverted T-shape and includes a large-diameter section and a small-diameter section; the plastic casing 1 is substantially in a circular tubular shape and has an LED connecting hole formed at the front end of the plastic casing 1 and a wire exit formed at the rear end of the plastic casing 1; the plastic casing has a plurality of mounting brackets disposed on an outer wall of the plastic casing and used as for fixing a lamp sleeve for fixing the lamp string; the LED connecting hole has a diameter in corresponsive to the small-diameter section of the epoxy resin member; the whole LED luminaire 2 is plugged into the plastic casing 1, and the small-diameter section of the epoxy resin member passing through and extending out from the LED connecting hole; and the plastic casing 1 is filled up with a plastic filler, and the points at the pins and the connecting wire are packaged by plastic.

There are two pins, and the two pins are fixed by a wire frame to provide a physical insulation.

While the invention has been described by means of specific embodiments, numerous modifications and variations could be made thereto by those skilled in the art without departing from the scope and spirit of the invention set forth in the claims.

What is claimed is:

1. An LED lamp holder for a waterproof lamp string, comprising a plastic casing, and an LED luminaire; the LED luminaire including a light emitting chip, an epoxy resin member, a pin, a light emitting chip packaged into the cylindrical epoxy resin member and connected to the pin extended out from the epoxy resin member; each pin being connected to a connecting wire; the cylindrical epoxy resin member being substantially in an inverted T-shape and including a large-diameter section and a small-diameter section; the plastic casing being substantially in a circular tubular shape and having an LED connecting hole formed at the front end of the plastic casing and a wire exit formed at the rear end of the plastic casing; the LED connecting hole having a diameter in corresponsive to the small-diameter section of the epoxy resin member; the whole LED luminaire being plugged into the plastic casing, and the small-diameter section of the epoxy resin member passing through and extending out from the LED connecting hole; the plastic casing being filled up with a plastic filler, and the points at the pins and the connecting wire being packaged by plastic.

2. The LED lamp holder for a waterproof lamp string as claimed in claim 1, wherein the plastic casing has a plurality of mounting brackets disposed on an outer wall of the plastic casing and used as for fixing a lamp sleeve for fixing the lamp string.

3. The LED lamp holder for a waterproof lamp string as claimed in claim 1, wherein the pin comes with a quantity of two, and the two pins are fixed by a wire frame to provide a physical insulation.
